(19) United States
(12) Patent Application Publication
(10) Pub. No.: US 2014/0265363 A1
(43) Pub. Date: Sep. 18, 2014

(54) Foot-Activated Door Locking System

(71) Applicant: Mocklock, Inc., Knoxville, TN (US)

(72) Inventor: Harvey Mock, Knoxville, TN (US)

(21) Appl. No.: 14/212,888

(22) Filed: Mar. 14, 2014

Related U.S. Application Data
(60) Provisional application No. 61/791,749, filed on Mar. 15, 2013.

(51) Int. Cl. E05C 1/08

(52) U.S. Cl. CPC E05C 1/08
USPC 292/177

(57) ABSTRACT

A door locking system is provided herein. The door locking system includes an elongated foot bolt. The foot bolt is dimensioned to be received in a recess or a strike in a floor. The door locking system also includes a housing. The housing has upper and lower ends, with the upper and lower ends having aligned through-openings for slidably receiving the foot bolt. The housing also has opposing faces having through-openings for receiving respective attachment screws. Additionally, the system includes a biasing spring. The biasing spring is placed around a portion of the foot bolt, with the biasing spring being held in compression within the housing. The system is configured so that the foot bolt may be depressed downward through the aligned through-openings in the upper and lower ends of the housing for locking a door, but then released by depressing a detent.

### CROSS REFERENCE TO RELATED APPLICATIONS

This application claims the benefit of U.S. Application No. 61/791,749, filed Mar. 15, 2013. The provisional application was entitled “Foot Activated Door Locking System,” and is incorporated herein by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

1. Field of the Invention

The present invention relates to locking systems. More specifically, the invention relates to foot-activated door locking systems for an external entry door.

2. Technology in the Field of the Invention

Residential entry doors typically come in one of two types. The first type is a door that is hung onto a door frame using hinges. These doors are typically fabricated from wood, fiberglass, or steel laminate over press board. Hinged doors provide locking through one or more deadbolts and a latch in the door handle. The second type is a sliding door that rides along a track placed horizontally along the floor. These doors are typically plates of glass that are mounted within an aluminum or light steel frame. Sliding doors are locked using a latch that is rotated into engagement with a stem or bolt within the door frame. Additionally, a metal bar or wooden stick may be placed between the sliding pane and the end of the track to further prevent lateral movement of the door.

Existing locking systems provide little resistance to the motivated burglar. In the case of the swinging door, an intruder may generally break through the locks by kicking the door two or three times near the door handle. This serves to dislodge the deadbolt and the latch from metal door strikes that are screwed into the door jamb. In the case of the sliding glass door, the knowledgeable burglar knows that he can simply lift the frame around the glass door about ½ inch, thereby clearing the metal track. The bottom of the sliding door can then be pushed inward with force, breaking or even avoiding any existing locks.

A need exists for an improved locking system that does not rely solely on deadbolts or latches secured in strikes in a door jamb or frame. Further, a need exists for a locking system that prevents an intruder from gaining access to a residence through a sliding glass door merely by lifting up on the door frame.

### BRIEF SUMMARY OF THE INVENTION

A foot-activated door locking system is provided herein. The door locking system is useful for securing either a hinged entry door or a sliding door.

In one aspect, the door locking system first includes an elongated foot bolt. The foot bolt is preferably fabricated from steel, and is dimensioned to be received in an opening in a floor. Preferably, the bolt has a circular profile and is received in a cylindrical strike that is counter-sunk into the floor.

The locking system further includes a housing. The housing has upper and lower ends. The upper and lower ends have aligned through-openings for slidably receiving the foot bolt. Additionally, the housing has opposing faces. The faces have through-openings for receiving respective attachment screws.

The locking system also includes a plurality of attachment screws. These are used for securing the housing of the door locking system to a door. The door may be, for example, an external wooden door or a sliding glass door having an aluminum frame.

The locking system also includes a biasing spring. The biasing spring is placed around a portion of the foot bolt. The biasing spring is held in compression within the housing.

The locking system next includes a keeper pin. The keeper pin resides along the foot bolt within the housing. The keeper pin attaches the spring to the foot bolt so that when the foot bolt moves, the spring moves with it. Preferably, the foot bolt is attached to the spring proximate an upper end of the spring. In this way, the upper end of the spring moves up and down with the foot bolt.

The door locking system also has a detent. The detent resides above the housing, and is generally fixed at an angle of between 10 and 40 degrees relative to the housing. The detent has a through-opening for receiving the foot bolt. The detent acts as a friction plate, holding the foot bolt in place when the foot bolt is pressed downward into a locked position.

In this present invention, the foot bolt travels between unlocked and locked positions. The travel is preferably between about ¾ and 2 inches. The door locking system is configured so that the foot bolt may be depressed downward through the aligned through-openings in the upper and lower ends of the housing. The foot bolt lands in the cylindrical strike for locking the door. The foot bolt may be released by pressing on the detent, allowing the compressed spring to push the foot bolt back up into its unlocked position.

In one aspect, the door locking system includes a plate. The plate has through-openings that are aligned with the through-openings in the side of the housing. In this way, upon receiving the attachment screws, the plate is affixed to the housing. The plate then covers the spring and foot bolt within the housing.

Preferably, the foot bolt, the housing, the plate and the biasing spring are all fabricated from a steel material.

### BRIEF DESCRIPTION OF THE DRAWINGS

So that the manner in which the present invention can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIGS. 1A through 1C provide plan views of a door locking system of the present invention, in one embodiment. Here, the door locking system is front-mounted.

FIG. 1A is a front view of a portion of the door locking system. The foot bolt and spring are visible within the housing of the door locking system.

FIG. 1B is a side view of a portion of the door locking system of FIG. 1A. Here, a plate has been placed over a front of the housing.

FIG. 1C is a front view of the portion of the door locking system of FIG. 1A. The detent is visible over the housing, and an optional door strike is visible below the foot bolt.

FIGS. 2A through 2C provide plan views of a door locking system of the present invention, in an alternate embodiment. Here, the door locking system is side-mounted.

FIG. 2A is a front view of a portion of the door locking system. The foot bolt and spring are visible within the housing of the door locking system.

FIG. 2B is a side view of the portion of the door locking system of FIG. 2A. Here, a plate has been placed over a front of the housing. The detent is visible over the housing.

FIG. 2C is a front view of the portion of the door locking system in the alternate embodiment. The detent is visible over the housing, and an optional door strike is visible below the foot bolt.

FIG. 3 is an example of the door locking system of FIGS. 2A through 2C. The housing has been side-mounted to an aluminum frame of a sliding glass door.

FIGS. 4A and 4B are renditions of a template as may be used for the placement of starter holes into a door. The template may be sold to a consumer as part of the system herein.

In FIG. 4A, the template is in an unfolded position as may be presented to the consumer in an original kit.

In FIG. 4B, the template is in a folded position.

FIG. 5 shows an example of mounting a locking system using a backing plate, under an embodiment.

FIG. 6 show an example of a backing plate, under an embodiment.

### DETAILED DESCRIPTION OF CERTAIN EMBODIMENTS

FIGS. 1A through 1C provide plan views of a door locking system 100 of the present invention, in one embodiment. The system 100 employs a foot-bolt 110 for securing a door (not shown). The foot bolt 110 is a form of deadbolt lock used to secure a door in a locked position by inserting a metal (steel) shaft (foot bolt 110) into a cylindrical strike 150 (shown in FIG. 1C) mounted in the floor or door track. The locking system 100 is intended as an add-on lock to prevent intrusion through an exterior entry door.

Turning first to FIG. 1A, FIG. 1A provides a front view of a portion of the door locking system 100. The foot bolt 110 is seen extending through the housing 120 of the door locking system 100. Preferably, both the foot bolt 110 and the housing 120 are fabricated from a steel material.

The foot bolt 110 has an upper end 112 that defends a cap. The upper end 112 resides above the housing 120. Preferably, the upper end 112 is coated with a rubber or other non-slippery material. The foot bolt 110 also has a lower end 114. The lower end 114 extends below the housing 120.

The housing 120 has an upper end 122 and a lower end 124. The upper 122 and lower 124 ends define plates that have aligned through-openings (not shown). The through-openings slidably receive the foot bolt 110.

Residing between the upper 122 and lower 124 ends is a spring 130. The spring 130 is wound around the foot bolt 110 within the housing 120. The spring 130 has an upper end 132 proximate the upper end 122 of the housing 120, and a lower end 134 proximate the lower end 124 of the housing 120. The spring 130 is generally held in compression within the housing 120.

The spring 130 is connected to the foot bolt 110. In the arrangement of FIG. 1A, the upper end 132 of the spring 130 is connected to the foot bolt 110 by means of a keeper pin 135. In one aspect, the keeper pin 135 acts as a so-called cotter key, and is placed through a small through-opening in the foot bolt 110. Thus, when a downward force is applied to the foot bolt 110 through the cap at the upper end 112, the keeper pin 135 moves down with the bolt 110, and causes the spring 130 to move down with the bolt 110.

The door locking system 100 of FIG. 1A is designed to be front-mounted onto a door. Through-openings 102 are seen in the back of the housing 120 for receiving attachment screws. In the view of FIG. 1A, attachment screws are not seen. However, attachment screws are visible at 105 in FIG. 1C, discussed below.

FIG. 1B is a side view of the portion of the door locking system 100 of FIG. 1A. Here, a plate 128 has been placed over a front of the housing 120. The plate 128 is held in place with the same attachment screws which pass through openings in the face plate 128 and then through openings 102 in the back of the housing. Along with side walls 126, the plate 128 provides a cover for the foot bolt 110 and spring 130 within the housing 120.

FIG. 1C is a front view of the portion of the door locking system 100 of FIG. 1A. In FIG. 1C, the plate 128 is again seen secured to the housing 120. In this view, the attachment screws 105 are also visible. The attachment screws 105 run through the plate 128, through the through-openings 102 in the housing 120, and into a door, thereby securing the housing 120 to the door.

In FIG. 1C, a detent 140 is also visible. The detent 140 resides over the housing 120. The detent 140 rests at a fixed angle over the upper end 122 of the housing 120. In one aspect, the angle is between 10 and 45 degrees relative to the housing 120.

The detent 140 serves as a friction plate. In this respect, the detent 140 includes a through-opening that frictionally receives the foot bolt 110 just above the upper end 122 of the housing 120. When the button shaped cap 112 of the foot bolt 110 is pressed downward through the housing 120, the detent 140 holds the foot bolt 110 in place, preventing the biasing spring 130 from forcing the foot bolt 110 back up. The foot bolt 110 may be released by gently pressing down on the detent 140, thereby removing the frictional hold.

It is understood that the foot bolt 110 is designed to be depressed using the user's foot. The bottom 114 of the foot bolt 110 is dimensioned to land in a strike. A strike is seen in FIG. 1C at 150. The strike 150 is preferably a cylindrical body forming a bore 155 therein. In the arrangement of FIG. 1C, the strike 150 has a closed bottom wall 154. However, the strike 150 may be open at the bottom 254, as shown in strike 250 of FIG. 2C. The strike in FIG. 2C also includes bore 255.

When the foot bolt 110 is pushed down into the strike 150, the foot bolt 110 is held in a locked position by the detent 140. In this position, the spring 130 is in a state of extreme compression. As noted, the foot bolt 110 may be released when the user pushes the detent 140. This removes the frictional force holding the foot bolt 110, allowing the foot bolt 110 to return to its unlocked position. More specifically, the biasing spring 130 pushes the foot bolt 110 back to an upward state. This position is shown in FIGS. 1A through 1C.

As can be seen, the door locking system 100 is front-mounted. This means that the attachment screws 105 enter the housing 120 through the front plate 128. However, it is preferred that the screws 105 enter the housing 120 through the side.

Referring to FIG. 1A, the housing 120 of locking system 100 may under one embodiment comprise a height of 3.5 inches and a width of 1.250 inches. The through openings 102 may under one embodiment comprise a diameter of 0.125 inches. The bolt 110 may under one embodiment comprise a diameter of 0.312 inches. Referring to FIG. 1B, the bolt 110 may under one embodiment comprise a length of 5.70 inches. Under one embodiment the distance from the right edge of side wall 126 to left edge of front plate 128 may be 1.350 inches. Under one embodiment the distance from the right edge of side wall 126 to left most edge of detent 140 may be 1.634 inches under one embodiment. Referring to FIG. 1C, the vertical distance between center points of the attachment screw locations 102 may be 2.080 inches under an embodiment.

FIGS. 2A through 2C provide plan views of a door locking system 200 of the present invention, in an alternate embodiment. The door locking system 200 is identical to the door locking system 100 discussed above, except for the placement of through-openings in the housing 220. In this respect, attachment screws 205 are run through the sides 226 of the housing 220, rather than through the plate and the back. This allows the door locking system 200 to be side mounted.

FIG. 2A is a front view of a portion of the door locking system 200. A foot bolt 210, spring 232, and keeper pin 235 are visible within a housing 220 of the door locking system 200. The foot bolt 210 has an upper end 212 that defends a cap 212. The upper end 212 resides above the housing 220. Preferably, the upper end 212 is coated with a rubber or other non-slippery material. The foot bolt 210 also has a lower end 214. The lower end 214 extends below the housing 220

FIG. 2B is a side view of the portion of the door locking system 200 of FIG. 2A. Here, a plate 228 has been placed over a front of the housing 220. The detent 240 is visible over the housing 220.

FIG. 2C is a front view of the portion of the door locking system 200 in the alternate embodiment, with a front plate 228 attached.

Components of the door locking system 200 need not be discussed, as they operate identically to the door locking system 100 of FIGS. 1A through 1C, other than the manner in which the attachment screws 205 go through the housing 220 and into a door.

Referring to FIG. 2A, the vertical distance between the position of the keeper pin 235 and the bottom edge of the bolt 210 may be 3.5 inches under an embodiment. The diameter of the spring 232 may be 0.375 inches under an embodiment. Referring to FIG. 2B, the vertical distance between center points of attachment screw 205 positions may be 2.080 inches under an embodiment.

FIG. 3 is an example of the door locking system 200 of FIGS. 2A through 2C. The housing 220 has been secured to a frame 275 of a sliding glass door 270. The tip of a pencil 260 shows where a hole is to be drilled in a floor track 285 to make room for the cylindrical strike 250.

FIGS. 4A and 4B are renditions of a template as may be used for the placement of starter holes into a door. The template may be sold to a consumer as part of the system 100 or 200 herein.

In FIG. 4A, a template 400A is shown. The template 400A is in an unfolded or flat position. This is the state in which the template 400A may be presented to the consumer in an original kit. Preferably, the template 400A is fabricated from heavy paper stock or light cardboard having a wax finish. The template 400A includes surface sections 410, 430 and 450 and fold lines 420 and 440. The template also features a bottom edge 480 and placement indicators 460 and 470.

In FIG. 4B, a template 400B is shown. This is the template 400A of FIG. 4A, but in a folded position. In using template 400A to identify starter hole locations, the surface 430 of template 400A is placed on the front surface of frame 275 (see FIG. 3) with the bottom edge 480 of template 400A aligned with the bottom edge of the frame 275. Template 400A is then folded along folding edge 440. This results in the folded template 400B. The position indicators 470 now indicate positions for pilot holes to be drilled into inner door surface 280 (see FIG. 3). FIG. 4B shows the locking system 200 in broken lines superimposed over the folded template 400B. FIG. 4B therefore indicates placement of the locking system on the door surface 280 using the position indicators to properly align the through openings of the locking system 200 for installation.

In practice, pilot holes are drilled into the door material using the template 400B. The housing 220 is fastened using, for example, either wood screws or self-tapping metal screws. Preferably, a ¼ inch clearance is allowed between the bottom 214 of the foot bolt 210 and the floor or track 285. The metal foot bolt 210 is inserted into a ½ inch round metal strike 250 placed into the floor or door track 285 for locking.

Beneficially, the door locking systems 100, 200 do not allow the removal of sliding doors by lifting them off their roller track, which is the “normal” break-in point for many forced entries. The current method of securing a sliding door is with an integrated lock in the handle which does not prevent lifting the door from its tracks, or the newer flip down security bar that fits into a receiver on the back of the sliding door (or the homemade version in the form of a stick or broom handle). These methods do prevent the door from being slid open but do nothing for entry by lifting the door frame and then removing the door from its track.

The door locking systems 100, 200 can be used to secure a standard entry door, patio or French door by being installed on the back of the door. Due to the placement of the locking system at the bottom of a door, the force needed to break the lock out of its strike is much greater than that of the deadbolt alone.

Under an embodiment, a door locking system may include one or more sensors that detect the transition of a bolt between locked and unlocked positions. With reference to FIGS. 1A-1C, it is understood that a foot bolt 110 of a locking system 100 is designed to be depressed using the user's foot. The bottom 114 of the foot bolt 110 is dimensioned to land in a strike. A strike is seen in FIG. 1C at 150. The strike 150 is preferably a cylindrical body forming a bore 155 therein. In the arrangement of FIG. 1C, the strike 150 has a closed bottom wall 154. Under one embodiment, the strike 150 itself may incorporate a sensor which monitors the surface of the bore 155 or otherwise detects the presence/absence of the bolt 114 in the strike's bore 155. When the bolt 110 is engaged or placed in a locked position, the sensor detects a crossing of the bolt 114 across such surface or simply detects the presence of the bolt 114 in the bore 155.

The locking system 100 may implement alternative methods for detecting a bolt transition event. For example, the locking system 100 may incorporate a fixed plate and a moving plate separated by dielectric material. The fixed plate may be the lower end 124 of the housing 120. The moving plate may couple with or form a part of the spring 130 itself. The moving plate moves downward and upward together with the motion of the spring 130. The housing 120 may include dielectric material between the plates. Of course, such material should be sufficiently malleable (or otherwise properly configured within the housing 120) to accommodate translation of the spring 130 from biased and unbiased positions. The plates are then coupled to an electrical source. As the moving plate changes position in accord with the movement of the bolt 110 from unlocked to locked position, the moving plate may approach the fixed plate 124, thereby changing capacitance across the plates. A change in capacitance indicates a change in state, i.e. a locking or unlocking of the door locking mechanism.

Under an embodiment, the spring 130 (or 230) itself may incorporate variable resistance material which registers variable resistance (Ohm) values as the spring 130 moves between biased and unbiased positions. A detected change in resistance values indicates a shift between the bolt's locked and unlocked position.

As yet another example, the lower end 114 of the bolt 110 may form a conductive coupling with the bore 155 or the bottom surface 154 of the strike 150. The removal of the bolt 114 from the strike 150 breaks the conductive coupling which is detectable as an open circuit or an electrical state change. Such change in state corresponds to a transition of the bolt 110 from locked to unlocked position.

The door locking system may also be communicatively coupled to a LAN located at the home or structure associated with the monitored door. Circuitry within the housing 120 (or 220) of the door locking system may report the status of the bolt 110, i.e. in locked or unlocked position. The LAN may further be coupled to a WAN or more generally to the INTERNET, thereby enabling communication with a remote server hosting at least one application and associated memory for maintaining the status of the locking system 100 (or 200). When the bolt 110 changes state, i.e. shifts from an unlocked to locked position, the remote server receives notice of the change and may report status information to a mobile computing platform such as a tablet, a laptop or a smartphone. In such manner, a user is able to monitor the status of the locking system 100 remotely and in real time.

FIG. 5 shows an example of mounting a locking system using a backing plate. FIG. 5 shows a bolt 510, a housing 520, and a detent 540. The locking system functions in a manner similar to locking system 100 with the exception of using a backing plate 530 to mount the housing 520 to a door. FIG. 5 shows a backing plate 530 which includes four arms 550. Each arm 550 includes a through opening 545. Two additional through openings 560 may be drilled through the backing plate itself as seen in FIG. 6. The through openings may comprise ⅛ inch openings under an embodiment.

In mounting the plate, a user places the backing plate 530 on the surface of a door and secures the backing plate using two screws which pass through the through holes 560 and into the door. Under an embodiment, wood or sheet metal screws are used depending upon the material of the door. The housing 520 then fits over the arms 550 of the backing plate 530 such that through openings 545 align with corresponding holes 555 in the housing 530. The aligned openings 545, 555 receive four screws to secure the housing to the backing plate. Self tapping screws may be used to secure the housing to the backing plate 530.

While it will be apparent that the inventions herein described are well calculated to achieve the benefits and advantages set forth above, it will be appreciated that the inventions are susceptible to modification, variation and change without departing from the spirit thereof.

I claim:

1. A door locking system, comprising:
an elongated foot bolt dimensioned to be received in an opening in a floor;
a plurality of attachment screws;
a housing comprising:
upper and lower ends, with the upper and lower ends having aligned through-openings for slidably receiving the foot bolt, and
opposing faces having through-openings for receiving respective attachment screws;
a biasing spring placed around at least a portion of the foot bolt;
a keeper pin placed along or through the foot bolt within the housing, operatively attaching the foot bolt to the spring; and
a detent residing above the housing at an angle of between about 10 and 40 degrees from the housing, the detent also having a through-opening for receiving the foot bolt; and
wherein the door locking system is configured so that the foot bolt may be depressed downward through the aligned through-openings in the upper and lower ends of the housing and into a recess for locking a door, but then released by depressing the detent.

2. The door locking system of claim 1, wherein the foot bolt and the housing are fabricated substantially from a steel material.

3. The door locking system of claim 2, further comprising:
a plate having through-openings, wherein the through-openings in the plate are aligned with the through-openings in a back of the housing so that upon receiving the attachment screws, the plate is affixed to the housing.

4. The door locking system of claim 3, further comprising:
a strike configured to be counter-sunk into a floor below the foot bolt, the strike having an inner diameter that is dimensioned to receive an outer diameter of the foot bolt as the recess.

5. The door locking system of claim 4, wherein the floor is a wood floor, a concrete floor, or a floor track for a sliding door.

6. The door locking system of claim 4, wherein:
the strike has a circular profile; and
the foot bolt also has a circular profile.

7. The door locking system of claim 4, wherein a lower end of the foot bolt extends at least 1 inch (2.54 cm) below the lower end of the housing when the foot bolt is depressed into the anchor.

8. The door locking system of claim 4, wherein the door is fabricated from wood or fiber glass.

9. The door locking system of claim 4, wherein:
the door is a sliding glass door having an aluminum or light metal frame; and
the attachment screws are run into the frame.

10. The door locking system of claim 4, wherein the foot bolt has a travel of between about ¾ inches (1.91 cm) and 2.0 inches (5.08 cm) between unlocked and locked positions.

11. The door locking system of claim 1, wherein:
the keeper pin extends through an opening in the foot bolt; and
the keeper pin connects the foot bolt to the biasing spring proximate an upper end of the spring.

12. The door locking system of claim 1, wherein:
the opposing faces are left and right sides; and
the housing is side-mounted.

13. The door locking system of claim 1, wherein:
the opposing faces are front and back sides;
the housing is front-mounted; and
the housing comprises a removable plate that serves as the front side, with the plate being held onto the housing by means of the attachment screws.

14. The door locking system of claim 1, wherein the biasing spring is held in compression within the housing.

15. A method of locking a door, comprising:
providing a door locking system comprising:
a housing having:
upper and lower ends, with the upper and lower ends having aligned through-openings for slidably receiving the foot bolt, and
opposing faces having through-openings for receiving respective attachment screws;
a biasing spring placed around at least a portion of the foot bolt;
a keeper pin placed along or through the foot bolt within the housing, operatively attaching the foot bolt to the spring; and
a detent residing above the housing at an angle of between about 10 and 40 degrees from the housing, the detent also having a through-opening for receiving the foot bolt;
securing the housing to a door above a recess in a floor surface;
locking the door by pressing the foot bolt, thereby causing the foot bolt to travel from an unlocked position wherein the foot bolt clears the recess, downward to a locked position wherein a lower end of the foot bolt resides within the recess; and
releasing the foot bolt from its locked position by depressing the detent.

16. The method of claim 15, wherein:
the foot bolt and the housing are fabricated substantially from a steel material; and
the method further comprises:
securing the housing to the door by running attachment screws through respective through-openings in the plate, wherein the through-openings are aligned with the through-openings in a back of the housing so that upon receiving the attachment screws, the plate is affixed to the housing.

17. The method of claim 16, wherein the locking system further comprises a strike configured to be counter-sunk into a floor below the foot bolt, the strike having an inner diameter that is dimensioned to receive an outer diameter of the foot bolt as the recess.

18. The method of claim 17, wherein:
the floor is a wood floor, a concrete floor, or a floor track for a sliding door; and
a lower end of the foot bolt extends at least 1 inch (2.54 cm) below the lower end of the housing when the foot bolt is depressed into the strike.

19. The method of claim 16, wherein:
the door is a sliding glass door having an aluminum or light metal frame; and
the attachment screws are run into the frame; and
securing the door locking system to a door comprises running the attachment screws into the aluminum frame.

20. The method of claim 16, wherein:
the keeper pin extends through an opening in the foot bolt;
the keeper pin connects the foot bolt to the biasing spring proximate an upper end of the spring; and
the biasing spring is held in compression within the housing.

21. The method of claim 16, wherein:
the door is fabricated from wood or fiberglass; and
securing the door locking system to a door comprises running the attachment screws into the door.
